(19) United States
(12) Patent Application Publication
(10) Pub. No.: US 2025/0228737 A1
(43) Pub. Date: Jul. 17, 2025

(54) VIBRATORY STIMULATION APPARATUS

(71) Applicant: TOYOTA BOSHOKU KABUSHIKI KAISHA, Aichi (JP)

(72) Inventors: Tatsuo KAWAI, Aichi (JP); Hidetaka NAGAYASU, Aichi (JP); Kyoko MORI, Aichi (JP)

(73) Assignee: TOYOTA BOSHOKU KABUSHIKI KAISHA, Aichi (JP)

(21) Appl. No.: 19/012,110

(22) Filed: Jan. 7, 2025

(30) Foreign Application Priority Data
Jan. 16, 2024 (JP) 2024-004443

(51) Int. Cl. A61H 23/02

(52) U.S. Cl. CPC A61H 23/0254; A61H 2201/0149; A61H 2201/1635; A61H 2201/164; A61H 2201/165; A61H 2201/5005; A61H 2203/0431; A61H 2205/06; A61H 2205/106; A61H 2205/108

(57) ABSTRACT

A vibratory stimulation apparatus in the present disclosure includes a vibration applicator configured to apply a vibration to a body of a user, and a controller configured to control an operation of the vibration applicator. The controller is capable of executing a vibration control that cyclically changes a vibration amplitude in a state where the vibration amplitude is set at a value greater than zero.

### CROSS-REFERENCE TO RELATED APPLICATIONS

The present application claims the benefit of Japanese Patent Application No. 2024-004443 filed on Jan. 16, 2024 with the Japan Patent Office, the disclosure of which is incorporated herein in its entirety by reference.

### BACKGROUND

The present disclosure relates to a vibratory stimulation apparatus for encouraging venous return (also referred to as “milking action”) and a neural activity (a projection to motor neurons from receptors in muscles and tendons via sensory neurons and intermediate neurons) of a user.

For example, the chair massager disclosed in Japanese Unexamined Patent Application Publication No. 2000-262578 is configured to operate a vibration generator in a state where the maximum vibration amplitude of a vibration generated with the vibration generator (hereinafter, simply referred to as “vibration amplitude”) is set at a fixed value.

### SUMMARY

Inventors and other persons have found from tests and researches that “the user feels great discomfort when the vibration generator is operated continuously in a state where the vibration amplitude of the vibration applied to the body is kept at a fixed value”. The present disclosure provides one example of the vibratory stimulation apparatus in view of the aforementioned point.

Preferably, a vibratory stimulation apparatus comprises, for example, at least constituent elements to be described below.

The constituent elements are a vibration applicator configured to apply a vibration to a body of a user, and a controller configured to control an operation of the vibration applicator. The controller is capable of executing a vibration control that cyclically changes a vibration amplitude in a state where the vibration amplitude is set at a value greater than zero.

According to the above configuration, the vibratory stimulation apparatus achieves a cyclic change of the vibration amplitude and can therefore inhibit the user from feeling great discomfort.

The vibratory stimulation apparatus may have, for example, the following configuration.

Preferably, a frequency of the vibration to be applied to the body is 20 Hz or higher and 120 Hz or lower. Preferably, the controller is configured so that a minimum value of the vibration amplitude is 0.1 mm or more. Furthermore, it is preferable that a difference between the minimum value of the vibration amplitude and a maximum value of the vibration amplitude is 0.1 mm or more.

Furthermore, in the vibratory stimulation apparatus whose vibration applicator includes a first vibrator configured to apply the vibration to a right half of the body of the user and a second vibrator configured to apply the vibration to a left half of the body of the user, it is preferable that a phase of a first cycle is shifted with respect to a phase of a second cycle.

The first cycle is a vibration amplitude change cycle of the first vibrator. The second cycle is a vibration amplitude change cycle of the second vibrator. The vibration amplitude change cycles are cycles in which the vibration amplitude changes cyclically during the vibration control.

The present disclosure can be also understood as a method of stimulation with a vibration that is achieved by the above vibratory stimulation apparatus.

### BRIEF DESCRIPTION OF THE DRAWINGS

Example embodiments of the present disclosure will be described hereinafter with reference to the accompanying drawings, in which:

FIG. 1 is a diagram illustrating a seat according to a first embodiment;

FIG. 2 is a block diagram of an electrical system of the seat according to the first embodiment;

FIG. 3 is a diagram showing drive waveforms of a vibration applicator according to the first embodiment;

FIG. 4A is a diagram illustrating an example of attaching a vibration applicator according to a second embodiment;

FIG. 4B is a diagram illustrating an example of attaching the vibration applicator according to the second embodiment; and

FIG. 5 is a diagram illustrating a seat according to a third embodiment.

### DETAILED DESCRIPTION OF EXEMPLARY EMBODIMENTS

Embodiments of the invention below show examples of embodiments within the technical scope of the present disclosure. In other words, invention-specifying matters and the like recited in the claims are not limited by specific configurations, structures, or the like indicated in the below-described embodiments.

It should be noted that a member or a portion described at least with a reference numeral is at least one in number except in a case of being accompanied by restrictive words such as “only one”. The vibratory stimulation apparatus provided in the present disclosure comprises at least one of a constituent element such as a member or a portion described at least with a reference numeral, or a structural part illustrated.

### First Embodiment

The present embodiment is an example in which the vibratory stimulation apparatus and a method of stimulation with a vibration according to the present disclosure are applied to seats such as vehicle seats and easy chairs.

### 1. Overview of Seat

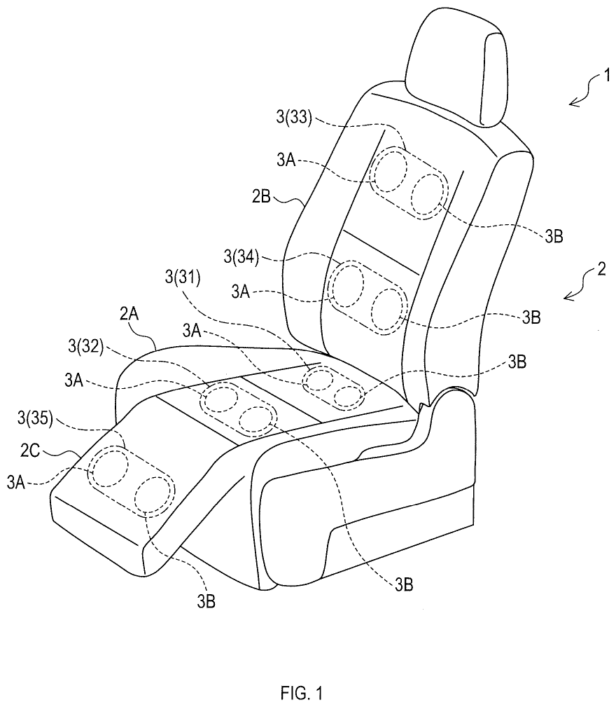

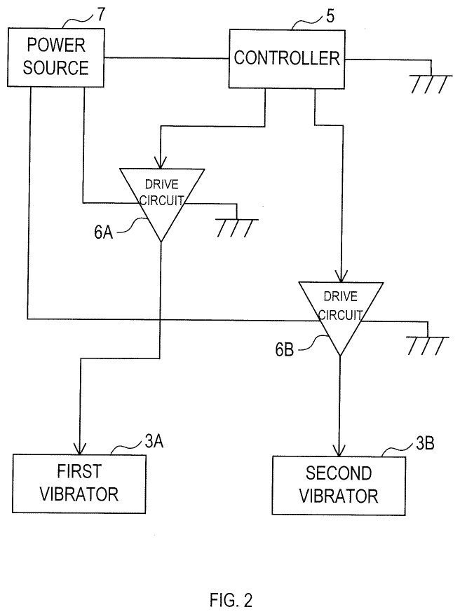

As illustrated in FIG. 1, a seat 1 according to the present embodiment comprises a seat body 2, at least one (two or more in the present embodiment) vibration applicator 3, and a controller 5 (see, FIG. 2).

The seat body 2 includes at least one of a seat cushion 2A, a seatback 2B, or an ottoman 2C. The seat cushion 2A supports a lower body of an occupant such as legs. The seatback 2B supports an upper body of the occupant such as the hip and the back. The ottoman 2C supports a part of the lower body of the occupant below knees such as calves.

Each vibration applicator 3 applies a vibration to a user of the vibratory stimulation apparatus, that is, the body of the user of the seat 1. In the present embodiment, at least one vibration applicator 3 is arranged in each of the seat cushion 2A, the seatback 2B, and the ottoman 2C.

Specifically, there are arranged vibration applicators 31 and 32 in the seat cushion 2A. In the seatback 2B, there are arranged vibration applicators 33 and 34. In the ottoman 2C, there is arranged a vibration applicator 35. Hereinafter, all the vibration applicators 31 to 35 or any vibration applicator is referred to as “vibration applicator 3”.

Each vibration applicator 3 includes a first vibrator 3A and a second vibrator 3B. The first vibrator 3A applies the vibration to the right half of the body of the user. The second vibrator 3B applies the vibration to the left half of the body of the user.

Each first vibrator 3A and each second vibrator 3B include vibrating elements configured to be driven by an electric actuator.

The controller 5 is a controller to control an operation of the vibration applicator 3, that is, operations of the first vibrator 3A and the second vibrator 3B. The controller 5 can execute a vibration control and a simulated motion control.

The vibration control is a control to cyclically change a maximum vibration amplitude of the vibration applied with the vibration applicator 3 in a state where the maximum vibration amplitude is set at a value greater than zero. The simulated motion control is a control to cause a phase of a first cycle to be shifted with respect to a phase of a second cycle.

The first cycle is a vibration amplitude change cycle of the first vibrator 3A. The second cycle is a vibration amplitude change cycle of the second vibrator 3B. The vibration amplitude change cycles are cycles in which the vibration amplitude changes cyclically during the vibration control.

FIG. 2 shows that a first drive circuit 6A receives a command of the controller 5, to thereby drive the first vibrator 3A. A second drive circuit 6B receives a command of the controller 5, to thereby drive the second vibrator 3B. A power source 7 supplies an electric power to the controller 5, the first drive circuit 6A, the second drive circuit 6B, and the like.

### 2. Details of Vibration Control and Simulated Motion Control

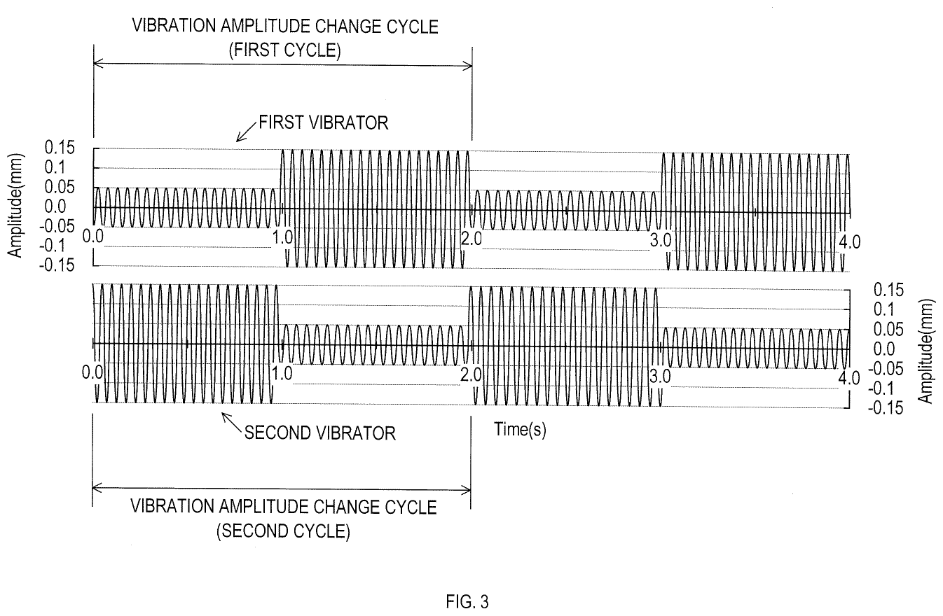

FIG. 3 is a chart showing a change in a maximum vibration amplitude of the first vibrator 3A and a change in a maximum vibration amplitude (hereinafter, simply referred to as “vibration amplitude”) of the second vibrator 3B. The controller 5 cyclically changes the vibration amplitudes of the first vibrator 3A and the second vibrator 3B in a state where the vibration amplitudes are set at values greater than zero.

In the cyclic change of the vibration amplitude, the controller 5 controls the vibration applicator 3 so that a frequency of the vibration applied to the body is 20 Hz or higher and 120 Hz or lower, a minimum value of the vibration amplitude is 0.1 mm or more, and a difference between the minimum value of the vibration amplitude and the maximum value of the vibration amplitude is 0.1 mm or more.

In the present embodiment, the frequency of the vibration applied to the body is 80 Hz. The minimum value of the vibration amplitude is 0.1 mm. The difference between the minimum value of the vibration amplitude and the maximum value of the vibration amplitude is 0.2 mm.

Moreover, the controller 5 causes the phase of the first cycle to be shifted with respect to the phase of the second cycle. It should be noted that, in the present embodiment, the vibration amplitude changes so that the vibration amplitude change cycle is in the form of a square wave, and the first cycle and the second cycle are the same. Moreover, a phase shift between the first cycle and the second cycle is one-half of the vibration amplitude change cycle.

### 3. Features of Seat According to Present Embodiment

The seat (in which the vibratory stimulation apparatus and/or the method of stimulation with a vibration may be implemented) according to the present embodiment can perform the vibration control that cyclically changes the vibration amplitude in a state where the vibration amplitude is set at a value greater than zero.

According to such a configuration, the vibratory stimulation apparatus achieves a cyclic change of the vibration amplitude and can therefore inhibit the user from feeling great discomfort.

More specifically, the vibratory stimulation apparatus can continuously apply a vibration that increases a muscle strength and motor nerve activity in a short-term period, thereby enhancing a workout effect per a unit of time. Moreover, by applying another vibration greater than the aforesaid vibration, the vibratory stimulation apparatus can make a fundamental vibration less easily detectable, thereby reducing discomfort to the user.

### Second Embodiment

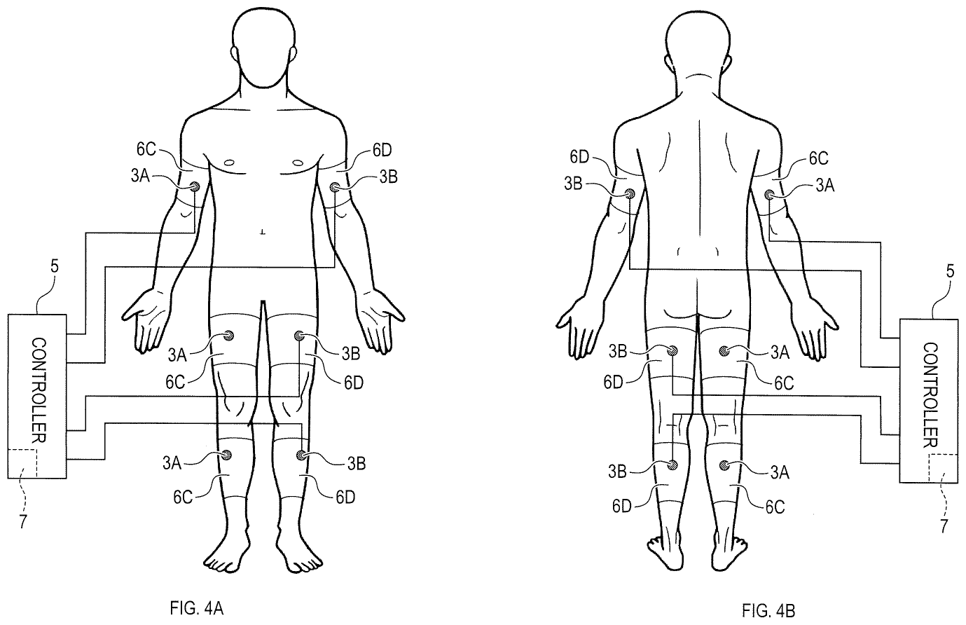

The first embodiment is an example in which the vibratory stimulation apparatus and/or the method of stimulation with a vibration according to the present disclosure is applied to seats. In contrast, the second embodiment provides, as illustrated in FIGS. 4A and 4B, a vibratory stimulation apparatus comprising a first fastener 6C configured to tightly fix the first vibrator 3A to the body of the user, and a second fastener 6D configured to tightly fix the second vibrator 3B to the body of the user.

The first fastener 6C and the second fastener 6D according to the second embodiment are fasteners such as hook-and-loop fasteners that are easily detachable. It should be noted that attachment positions of the first vibrator 3A and the second vibrator 3B, illustrated in FIGS. 4A and 4B, are examples.

Furthermore, a muscle to be vibrated may be any part such as the muscle belly, the tendon, and the like. This is because venous return and neural activity can be effectively encouraged in any part.

The second embodiment has been described in respect of its difference from the first embodiment. The same constituent element(s) and the like as in the first embodiment are denoted with the same reference numerals as in the first embodiment. Therefore, an overlapping description is omitted in the second embodiment.

### Third Embodiment

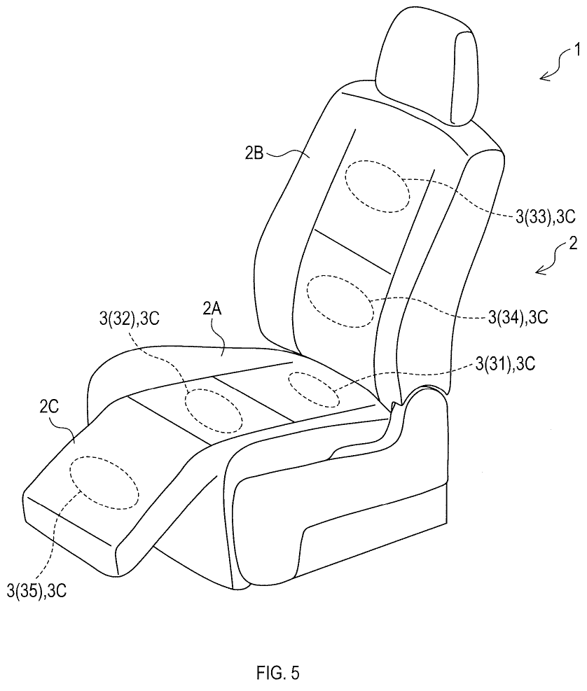

Each vibration applicator 3 according to the first embodiment comprises the first vibrator 3A for the right half of the body and the second vibrator 3B for the left half of the body. In contrast, each vibration applicator 3 according to a third embodiment comprises a single vibrator 3C as illustrated in FIG. 5.

As in the first embodiment, the controller 5 can execute a vibration control, on each vibration applicator 3, that is, on each vibrator 3C, that cyclically changes the vibration amplitude in a state where the vibration amplitude is set at a value greater than zero.

The third embodiment has been described in respect of its difference from the seat 1 according to the first embodiment. The same constituent element(s) and the like as in the first embodiment are denoted with the same reference numerals as in the first embodiment. Therefore, an overlapping description is omitted in the third embodiment.

### Other Embodiments

In the first to third embodiments, the vibration amplitude changes so that the vibration amplitude change cycle is in the form of a square wave. Moreover, the first cycle and the second cycle are the same, and the phase shift between the first cycle and the second cycle is one-half of the vibration amplitude change cycle. However, the present disclosure is not limited hereto.

For example, there may be provided a configuration in which the vibration amplitude changes so that the vibration amplitude change cycle is in the form of a sine wave; the phase shift between the first cycle and the second cycle is one fourth of the vibration amplitude change cycle; the first cycle and the second cycle are different cycles; or the vibration amplitude change cycle changes cyclically.

The first to third embodiments provide a configuration in which the vibration amplitude changes cyclically from 0.1 mm to 0.3 mm. However, the present disclosure is not limited hereto. For example, there may be provided a configuration in which the vibration amplitude centered at 0.2 mm changes cyclically from 0.1 mm to 0.3 mm. That is, the change in the vibration amplitude is not limited as long as the vibration amplitude has a specific value (for example, 0.1 mm) or more.

In the first to third embodiments, the frequency of the vibration amplitude applied to the body is 20 Hz or higher and 120 Hz or lower. The minimum value of the vibration amplitude is 0.1 mm or more, and the difference between the minimum value of the vibration amplitude and the maximum value of the vibration amplitude is 0.1 mm or more. However, the present disclosure is not limited hereto.

The first to third embodiments provide a configuration in which the two or more first vibrators 3A vibrate in the same phase. However, the present disclosure is not limited hereto. For example, there may be provided a configuration in which the first vibrators 3A vibrate with different phases.

The first to third embodiments provide a configuration in which the two or more second vibrators 3B vibrate in the same phase. However, the present disclosure is not limited hereto. For example, there may be provided a configuration in which the second vibrators 3B vibrate with different phases.

In the first and third embodiments, there is arranged at least one vibration applicator 3 in each of the seat cushion 2A, the seatback 2B, and the ottoman 2C. However, the present disclosure is not limited hereto. For example, there may be provided a configuration in which the vibration applicator 3 is arranged in only one of the seat cushion 2A, the seatback 2B, or the ottoman 2C.

In the first and third embodiments, the vibratory stimulation apparatus according to the present disclosure is applied to the vehicle seats. However, the present disclosure is not limited hereto. For example, the vibratory stimulation apparatus in the present disclosure can be also applied to seats used in other vehicles such as railway vehicles, ships and boats, and aircrafts, and to stationary seats used in theaters and households.

Furthermore, the present disclosure only has to be consistent with ideas of the present disclosure specified in the above-described embodiments, and is not limited to the above-described embodiments. Therefore, the present disclosure may be configured in combination of at least two embodiments of the above-described embodiments or may be configured so as to eliminate any of the illustrated constituent elements or the constituent elements described with reference numerals in the above-described embodiments.

What is claimed is:

1. A vibratory stimulation apparatus comprising:
a vibration applicator configured to apply a vibration to a body of a user; and
a controller configured to control an operation of the vibration applicator, the controller being configured to execute a vibration control that cyclically changes a vibration amplitude in a state where the vibration amplitude is set at a value greater than zero.

2. The vibratory stimulation apparatus according to claim 1, wherein the controller is configured to control the operation of the vibration applicator so that a frequency of the vibration amplitude to be applied to the body is 20 Hz or higher and 120 Hz or lower.

3. The vibratory stimulation apparatus according to claim 2, wherein the controller is configured to control the operation of the vibration applicator so that a minimum value of the vibration amplitude is 0.1 mm or more.

4. The vibratory stimulation apparatus according to claim 3, wherein the controller is configured to control the operation of the vibration applicator so that a difference between the minimum value of the vibration amplitude and a maximum value of the vibration amplitude is 0.1 mm or more.

5. The vibratory stimulation apparatus according to claim 1,
wherein the vibration applicator includes:
a first vibrator configured to apply the vibration to a right half of the body of the user; and
a second vibrator configured to apply the vibration to a left half of the body of the user,
wherein the controller is configured to execute a control that causes a phase of a first cycle to be shifted with respect to a phase of a second cycle,
wherein the first cycle is a vibration amplitude change cycle of the first vibrator,
wherein the second cycle is a vibration amplitude change cycle of the second vibrator, and
wherein the vibration amplitude change cycles are cycles in which the vibration amplitude changes cyclically during the vibration control.
